(19) United States
(12) Patent Application Publication
(10) Pub. No.: US 2015/0073319 A1
(43) Pub. Date: Mar. 12, 2015

(54) Controllable Compression Textiles Using Shape Memory Alloys and Associated Products

(71) Applicants: Bradley T. Holschuh, Cambridge, MA (US); Dava J. Newman, Cambridge, MA (US); Edward W. Obropta, Jr., Cape May Court House, NJ (US)

(72) Inventors: Bradley T. Holschuh, Cambridge, MA (US); Dava J. Newman, Cambridge, MA (US); Edward W. Obropta, Jr., Cape May Court House, NJ (US)

(73) Assignee: MASSACHUSETTS INSTITUTE OF TECHNOLOGY, Cambridge, MA (US)

(21) Appl. No.: 14/482,373

(22) Filed: Sep. 10, 2014

Related U.S. Application Data
(60) Provisional application No. 61/876,483, filed on Sep. 11, 2013.
(60) Provisional application No. 61/884,513, filed on Sep. 30, 2013.

(51) Int. Cl. A61H 1/00; B64G 6/00; A62B 17/00

(52) U.S. Cl. CPC A61H 1/008; A62B 17/008; B64G 6/00; A61H 2201/12
USPC 601/84

(57) ABSTRACT

An active compression garment includes at least one active textile member formed from a shape memory alloy (SMA) material to provide controllable compression to a body part of interest. The active compression garment may also include at least one contact for applying an electrical stimulus signal to the active textile member to cause the SMA material to return to a trained shape.

### CROSS REFERENCE TO RELATED APPLICATION

The present application claims the benefit of U.S. Provisional Patent Application Nos. 61/876,483, filed on Sep. 11, 2013, and 61/884,513, filed on Sep. 30, 2013, which are both incorporated by reference herein in their entireties.

### GOVERNMENT RIGHTS

This invention was made with government support under contract number NNX11AM62H awarded by NASA. The government has certain rights in this invention.

### FIELD

The subject matter described herein relates generally to textiles and, more particularly, to textiles that make use of shape memory alloys (SMAs) as well as techniques for forming such textiles and articles of manufacture formed from such textiles.

### BACKGROUND

Compression garments are garments that provide some degree of compression to a body part of a user for a specific purpose. Compression garments may be used in a variety of different applications including, for example, medical applications, sports applications, military applications, space applications, and cosmetic applications. Some medical applications include, for example, compressive stockings to improve circulation in a wearer's legs, compression garments to he worn by diabetes sufferers, compression garments to be worn by bum victims, and post-surgical compression garments to aid in recovery after a surgical procedure. Sports-related compression garments may be used, for example, to improve the delivery of oxygen to an athlete's muscles during a sporting event. In a military application, a compressive tourniquet might be used to reduce blood flow to an injured body part of a wounded soldier. Space-applications may include, for example, compressive space suits to provide required pressurization, to an astronaut's body when venturing outside of a spacecraft in space. Cosmetic applications might include girdles, corsets, and other body shapewear. any other applications for compression garments also exist.

Compression garments are typically implemented in one of two ways. In one approach, these garments are formed of tight fitting passive materials. While lightweight, these garments are usually difficult and time-consuming to get on and off. In the other approach, compression garments are fashioned using pneumatically-pressurized bladders. These garments can be put on and taken off relatively easily while the bladder is in a deflated state. However, such garments are typically bulky and restrict movement when inflated. There is a need for compression garments that are capable of overcoming one or more of the disadvantage of these conventional structures.

### SUMMARY

Compression garments are described herein that utilize shape memory alloys (SMAs) to provide enhanced operability and performance in compression garment applications. Also described are various techniques and strategies for forming textile materials out of SMAs that can be used in such compression garments. Compression garments using SMAs may be relatively lightweight, similar to conventional passive garments. These garments may also include the ability to control the pressure applied to a wearer, thus making them easy to don and doff during a low pressure state. It is believed that concepts, structures, and techniques disclosed herein represent the first technology that incorporates integrated shape changing materials to create compression textile garments having controllable pressure.

In accordance with one aspect of the concepts, systems, circuits, and techniques described herein, a compression garment comprises a homogeneous active textile member formed from a shape memory alloy (SMA) material to at least partially surround a body part of interest of a wearer for use in providing controllable compression to the body part of interest, the active textile member having a textile pattern with a natural expansion ability along an axis of expansion thereof, wherein the active textile member is trained to return to a predetermined expansion state along the axis of expansion when an external stimulus is applied.

In one embodiment, the active textile member is fully formed from SMA material and non-SMA material that has a melting temperature that is higher than an annealing temperature required to train the SMA material.

In one embodiment, the active textile member is fully formed from SMA material.

In one embodiment, the active textile member includes a flat knit structure.

In one embodiment, the active textile member includes a braid structure.

In one embodiment, the active textile member includes a biaxial braid structure.

In one embodiment, the active textile member includes an SMA knit panel.

In one embodiment, the active textile member comprises a plurality of SMA knit panels that are coupled together, wherein each panel in the plurality of SMA knit panels is trained to return to a predetermined expansion state along a corresponding axis of expansion, and the panels are coupled together with their axes of expansion in substantial alignment.

In one embodiment, the compression garment further comprises at least one terminal for use in applying an electrical stimulus signal to the active textile member, wherein the active textile member is trained to provide compression to the body part of interest in response to application of the electrical stimulus signal to the at least one terminal.

In one embodiment, the compression garment further comprises at least one terminal for use in applying an electrical stimulus signal to the active textile member, wherein the active textile member is trained to release compression of the body part of interest in response to application of the electrical stimulus signal to the at least one terminal.

In one embodiment, the compression garment further comprises: a holder to hold an energy source; and a switch to controllably couple the energy source to the active textile member as a stimulus signal.

In one embodiment, the homogeneous active textile member is formed from an SMA microwire material.

In accordance with another aspect of the concepts, systems, circuits, and techniques described herein, a compression garment comprises a homogeneous active textile member formed from a shape memory alloy (SMA) material, wherein the homogeneous active textile member is trained as an assembled unit to return to a desired shape upon application of a stimulus.

In one embodiment, the homogeneous active textile member includes a flat knit structure.

In one embodiment, the homogeneous active textile member includes a braid structure.

In accordance with still another aspect of the concepts, systems, circuits, and techniques described herein, a compression garment comprises a homogeneous active textile member formed from a shape memory alloy (SMA) material, the homogeneous active textile member including a plurality of SMA flat knit panels that are coupled together to form an active textile member adapted to provide controllable compression to a body part of a wearer, wherein each of the SMA flat knit panels in the plurality of SMA flat knit panels is separately trained to return to a desired memory shape in response to a stimulus.

In one embodiment, each of the SMA flat knit panels in the plurality of SMA flat knit panels is naturally expandable along an axis thereof and each of the SMA flat knit panels in the plurality of SMA flat knit panels has been trained to return to a similar memory shape, wherein the plurality of SMA flat knit panels are coupled together so that the axes of the panels are substantially aligned.

In one embodiment, the homogeneous active textile member is provided as a cuff.

In accordance with a further aspect of the concepts, systems, circuits, and techniques described herein, a compression garment comprises a homogeneous active textile member formed from a shape memory alloy (SMA) material to provide controllable compression to a body part of interest, the homogeneous active textile member including an SMA braid structure having a fully compressed state and a fully expanded state along an axis of expansion of the braid, wherein the homogeneous active textile member is trained to return to either a compressed state at or near the fully compressed state or an expanded state at or near the fully expanded state in response to a stimulus.

In one embodiment, the homogeneous active textile member has a passive diameter that is smaller than a diameter of a body part of interest and is trained to return to the compressed state in response to the stimulus.

In one embodiment, the homogeneous active textile member has a passive diameter that is larger than a diameter of a body part of interest and is trained to return. to the expanded state in response to the stimulus.

In accordance with a still further aspect of the concepts, systems, circuits, and techniques described herein, a method for use in fabricating a compression garment, comprises: creating a homogeneous active textile member from a shape mammy alloy (SMA) material; manipulating the homogeneous active textile member into a desired memory shape representing a shape to which the homogeneous active textile member will return in response to a stimulus; and annealing the homogeneous active textile member at an annealing temperature while in the desired shape to train the homogeneous active textile member.

In one embodiment, creating a homogeneous active textile member includes creating an SMA knit textile using SMA wire.

In one embodiment, creating a homogeneous active textile member includes creating an SMA braid using SMA wire.

### BRIEF DESCRIPTION OF THE DRAWINGS

The foregoing features may be more fully understood from the following description of the drawings in which:

FIG. 1 is a time-lapsed view of the deformation of an SMA wire and its return to a trained shape when a stimulus is applied;

FIG. 2 is a diagram illustrating a well knit architecture that may he used to form a homogeneous SMA textile in accordance with an embodiment;

FIG. 3 is a diagram illustrating a technique for forming a compression garment using individual SMA knit panels in accordance with an embodiment;

FIG. 4 is a diagram illustrating a technique for forming micrometer-scale SMA wires fur use in active textiles using a well known Taylor-wire process;

FIG. 5 is a diagram illustrating an exemplary bi-axial braid structure that may be formed almost entirely of SMA wire material in accordance with an embodiment; and

FIG. 6 is a flowchart illustrating a method for use in fabricating a compression garment.

### DETAILED DESCRIPTION

Techniques, concepts, systems, and articles of manufacture described herein relate to controllable compression garments and associated structures that are made from textiles comprising shape memory alloys (SM). In some embodiments, the textiles used to form the compression garments are fully or near fully formed from SMA materials (e.g., SMA micro-wires, SMA coils, etc.). Various techniques for forming and using such textiles are described herein. As will be described in greater detail, garments formed from SMA materials are capable of producing controllable compression to the body part of a wearer. In some embodiments, SMA materials are used to form knit-based textiles. In other embodiments, SMA materials are used to form braid-based textiles. Other types of fabric configurations may alternatively be used. In general, the SMA structures (e.g., SMA micro-wires, etc.) within a garment will be trained to change shape on a macro-level based on the summation of the individual deflection achieved by each SMA wire.

As used herein, the term “compression garment” is defined as a garment that is designed to provide compression to a body part of a wearer for a specific purpose, other than holding the garment on the wearer. Thus, a conventional pair of socks may provide some level of compression to a wearer's legs so that they do not fall down, but these are not considered compression garments for purposes of this disclosure. A compression stocking worn by a diabetic to improve circulation, on the other hand, is considered a compression garment. The word “garment” is used herein in a broad sense to encompass anything that may be worn on a body, regardless of size or location, and is not limited to items that are normally considered clothing. Thus, structures like bandages, tourniquets, and the like are considered to be garments herein. Compression garments are not limited to use with human wearers. That is, compression garments may also be made for use with animals.

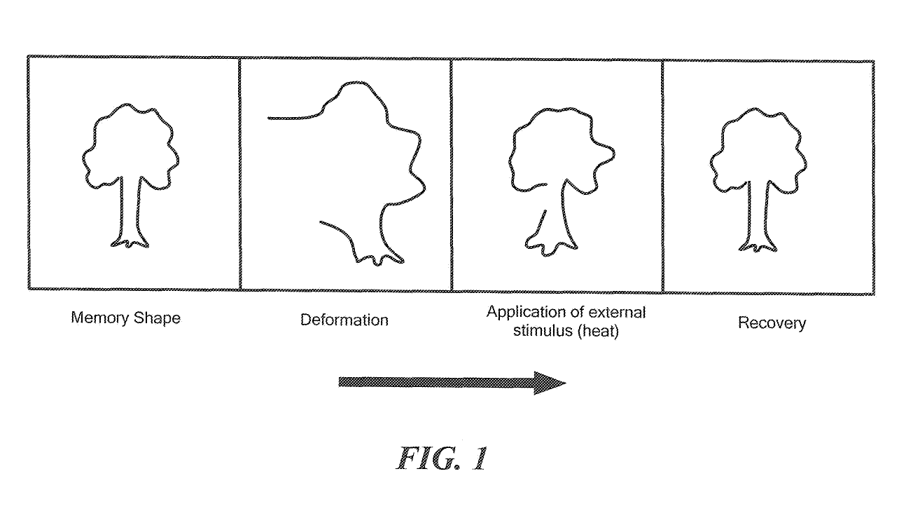

Shape memory alloys (SMAs) are a category of metal alloys that demonstrate a shape memory effect, which is the ability to return from a deformed state to a “remembered” state when exposed to a specific stimulus. This occurs as a result of a diffusionless solid-to-solid transformation between the alloy's austenitic and martensitic phases that is triggered by an external stimulus (see, e.g., J. Madden et al. “Artificial Muscle Technology; Physical Principles and Naval Prospects,” IEEE Journal of Oceanic Engineering, 29, 696-705 (2004)). Stimuli can take several forms, including externally applied stress, heat, magnetic fields, electrical signals, among others. Shape memory alloys also demonstrate super-elasticity which is the ability to fully recover a strain throughout a loading and unloading cycle, though hysteresis-based energy losses do occur (see, e.g., Qiao, L., et al., “Nonlocal Superelastic Model of Size-Dependent Hardening and Dissipation in Single Crystal Cu—Al—Ni Shape Memory Alloys”, Physical Review Letters, 106, 085504 1-4 (2011)). The deformations that can be recovered through the shape memory effect are significant. For example, FIG. 1 shows a time-lapse view of an SMA wire, deformed from its original configuration then exposed to heat, causing the sample to return to its un-deformed “memory” shape. SMA structures may be “trained” to remember a particular state or shape by, for example, placing the structure in the desired shape and then subjecting the structure to high temperatures for an operative time period.

SMAs have been extensively studied, and their shape memory and elastic properties have proven useful in a wide variety of applications, ranging from robotic actuators and prostheses to bridge restraints, valves, deformable glasses frames, biomedical devices, and even wearable garments (see, e.g., Berzowska, J. et al, “Kukkia and Vilkas: Kinetic Electronic Garments,” Ninth IEEE International Symposium on Wearable Computers, IEEE (2005); Johnson, R. et al., “Large Scale Testing of Nitinol Shape Memory Alloy Devices for Retrofitting of Bridges,” Smart Materials and Structures, 17 (2008); Yang, K. et al., “A Novel Robot Hand with Embedded Shape Memory Alloy Actuators,” Journal of Mechanical Engineering Science, 216, 737-745 (2002); Lee et al., “Biomedical Applications of Electroactive Polymers and Shape Memory Alloys,” Smart Structures and Materials 2002: Electroactive Polymer Actuators and Devices (EAPAD), IN Bar-Cohen, Y. (Ed.), SPIE; Pfeiffer, C., et al., “Shape Memory Alloy Actuated Robot Prostheses: Initial Experiments,” 1999 IEEE International Conference on Robotics and Automation, Detroit, Mich., IEEE (1999); Lu, A. et al, “Design and Comparison of High Strain Shape Memory Alloy Actuators,” International Conference on Robotics and Automation, Albuquerque, New Mexico, IEEE (1997)). The memory effect has been demonstrated in several alloy types, though the most common and commercially available alloy produced is NiTi (approximately 55% Nickel and 45% Titanium), under brands such as Nitinol® and Flexinol®. Some other alloys include, for example, silver-cadmium (AgCd), copper-aluminum-nickel (CuAlNi), manganese copper (MnCu), and others. Such alloys can be purchased in wire, tube, strip, or sheet form in varying thicknesses and diameters, and their deformation recovery capabilities scale with element size. In the discussion that follows, the use of NiTi as an SMA will be assumed. It should be appreciated, however, that other SMA materials may alternatively be used in connection with the techniques, structures, and systems described herein including, for example, those described above, alloys of zinc, copper, gold, and iron; as well as others.

To maximize the usefulness of SMA materials, studies have been conducted to determine optimal configurations for large strains and forces, optimal designs for bundle actuation schemes, and functional dependencies on fiber diameters. For example, one study analyzed and optimized SMA actuator bundles consisting of parallel wires of varying diameters (from 100-250 μm), demonstrating forces of up to 38N (see, e.g., De Laurentis, K, et al., “Optimal Design of Shape Memory Alloy Wire Bundle Actuators,” 2002 IEEE international Conference on Robotics & Automation. Washington, D.C., IEEE, 2002). Another study developed and tested a large force SMA linear actuator capable of lifting 100 lbs with a stroke length of 0.8 in (see Anadon, J. “Large Force Shape Memory Alloy Linear Actuator,” Department of Mechanical Engineering, University’ of Florida (2002)). Still another study determined that energy dissipation in SMA wires increases as their diameters decrease, and that both the transformation stresses and temperatures are subject to size effects (i.e., both stress and temperature hysteresis increase with decreasing wire diameters) (see Chen, Y. et al., “Size Effects in Shape Memory Alloy Microwires,” Acta Materialia, 59, 537-553.(2010)).

SMAs are widely available and relatively inexpensive. With proper design and manufacturing, SMAs can produce large forces, recover from large deformations, and can be integrated into textiles. A major limitation of SMAs however, is the small magnitude of recoverable strain. For example, state of the art SMAs demonstrate strains that peak in the single-digit percentage range (see, e.g., Chen, Y. et al., “Size Effects in Shape Memory Alloy Microwires,” Acta Materialia, 59, 537-553 (2010); and J. Madden et al. “Artificial Muscle Technology: Physical Principles and Naval Prospects,” IEEE Journal of Oceanic Engineering, 29, 696-705 (2004)). This poses challenges for applications that require large stroke lengths, In a controllable compression garment, for example, compression requires construction of a garment surrounding a body member. This is most easily achieved through length-wise (i.e., circumferential) constriction of a garment's individual active SMA elements. Based on the strain of SMAs alone, for example, it would be difficult to produce the counter-pressure (e.g., 30 kPa) required for a mechanical counter-pressure (MCP) space suit compression garment while simultaneously creating large changes in the garment shape to enable donning and doffing. However, it has been found that other useful features of SMAs may be exploited to allow them to produce the required compression (e.g., their superelasticity and large deformation abilities).

As described previously, in various embodiments, controllable compression garments are provided that are formed from active textiles that include SMAs. In some embodiments, the active textiles are fully or near fully formed from SMA materials. These types of textiles will he referred to herein as “homogeneous” SMA textiles. In some embodiments, active textiles are used that are 100% SMA material. A fully SMA textile allows the entire fabric to be “trained” into a particular shape at high temperature. In some embodiments, active textiles may be used that are less than 100% SMA material. In these textiles, the remaining materials may be formed of non-shape changing materials with similarly high melting points (e.g., stainless steel microfiber, etc.). When formed into a garment, some non-SMA material may be added to a “homogeneous” SMA textile in some embodiments. This may include, for example, the use of non-SMA threads to bind different portions of a garment together. This may also include, for example, the addition of one or more other structures to a garment (e.g., garment liners and/or outer shells made of conventional fabrics (cotton, nylon, etc.), and so on). In some embodiments, active textiles are used that are less than 99% SMA material, In some others, active textiles are used that are less than 95% SMA material. Various textile patterns may he used to form homogeneous SMA textiles. In the discussion that follows, a number of different homogeneous textile types will be described including, for example, a homogeneous SMA flat-knit structure and a homogeneous SMA bi-axial braid structure.

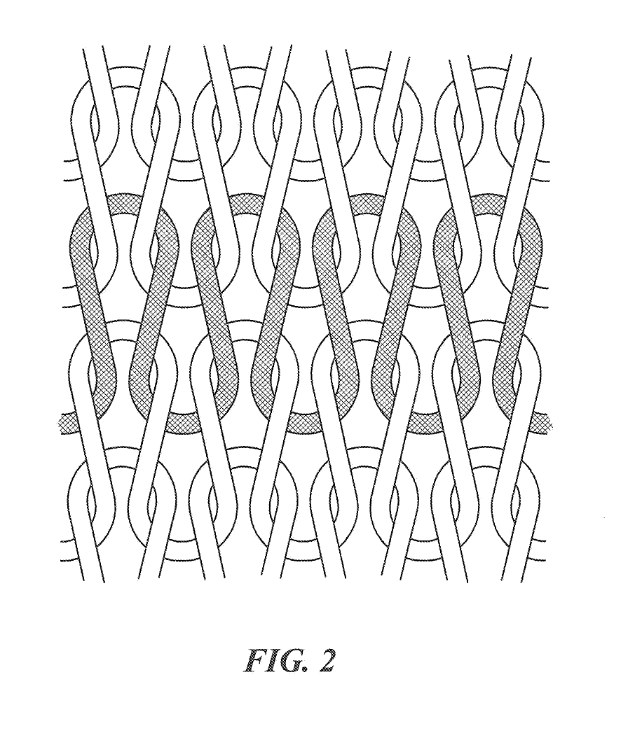

In some embodiments, flat-knit structures formed from SMA materials are used in controllable compression garments. As is well known, a knitted fabric typically uses a single set of yam or thread that is looped through itself to form the fabric. The yarn may be oriented in substantially the same direction through the entire garment. Knitted fabrics can use either a weft or warp knitted architecture, depending on whether the yarn moves along the length or the width of the fabric. Techniques for forming knit structures using yarns and threads are well known in the art. FIG. 2 is a diagram illustrating a weft knit architecture that may be used to form a homogeneous SMA textile in accordance with an embodiment. Warp architectures may alternatively be used. When formed entirely of an SMA material (or of an SMA material with some non-SMA material of similarly high melting point), the knit architecture of FIG. 2 can be trained as a complete textile, enabling the garment to remember complex shapes that would be difficult (if not impossible) to achieve if the SMA elements were limited to their pre-knit shape training state (as would be the case in a non-homogenous textile). This capability will enable the garment to be trained in specific ways to exploit the natural flexibility of the knit structure; namely, the ability to contract along a single axis when a stimulus is applied.

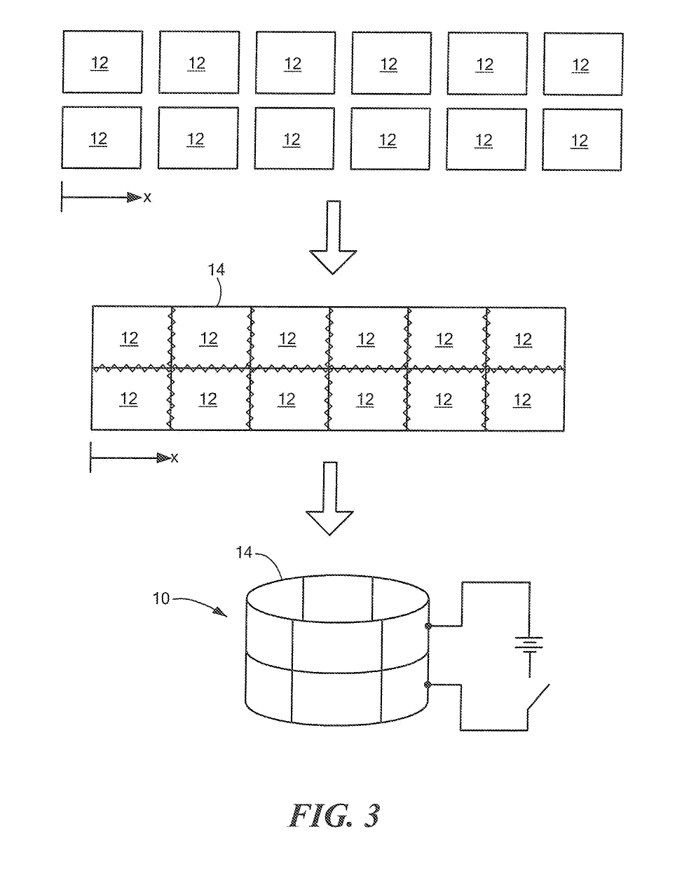

In some embodiments, SMA-based knit fabrics, such as the one shown in FIG. 2, are formed into individual panels that may then be coupled together to form a compression garment of a desired shape. The individual panels may be trained to contract or expand predominantly along a single axis. A compression garment may then be constructed piecewise using these panels, with the axes of the panels aligned to follow the local circumferential direction of the wearer. FIG. 3 is a diagram illustrating the use of this technique to form a compressive cuff 10. As shown, a number of separate SMA knit panels 12 are provided that are each trained to contract along a longitudinal axis x. The panels 12 are then stitched together with the contraction axes of the panels all oriented in the same direction to form an elongated fabric amber 14. The two ends of the elongated fabric member 14 may then be stitched together to form a cuff 10 that compresses in the circumferential direction when a stimulus is applied. Training of each panel 12 may be achieved by holding the panel in its desired active state while annealed at high temperature. To train a knit panel to contract (or expand) along its flexible axis, it simply needs to be stretched to the desired length along the axis of interest then annealed.

As will be appreciated, the above-described technique may be used to form controlled compression garments in virtually any shape. In general, for each part of a garment, the individual panels will need to be oriented in a manner that aligns the compressible dimension of the panel with the dimension. of the body part to which compression is to be applied. Any technique may be used to connect the various panels together including, but not limited to, stitching, gluing, knotting, binding, thermobonding, ultrasonic welding, and/or lacing.

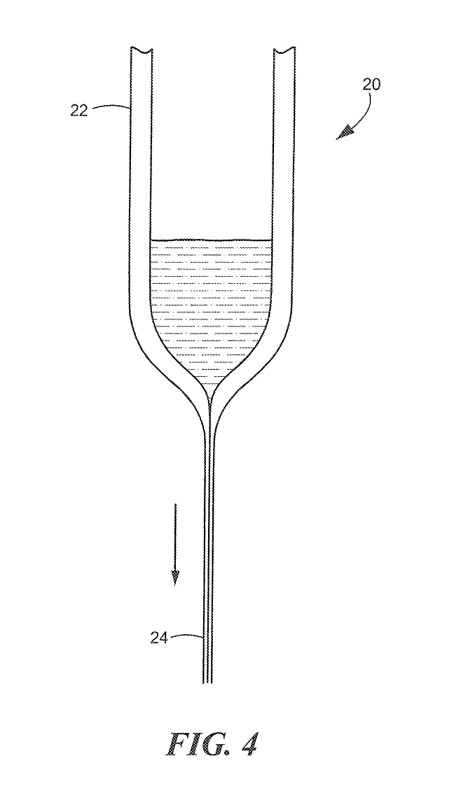

To use active materials in a textile, the active elements may often take a specific form depending on the nature of the desired textile. SMEs, for example, may take the form of either fine or coarse fibers/wires. In at least one embodiment, micrometer-scale alloy wires (i.e., microwires) may be formed for use in active textiles using the well known Taylor-wire process 20 illustrated in FIG. 4. In this process, a hollow glass tube 22 is filled with solid specimens of an alloy of interest. The tube and the allow is then melted (generally via an induction furnace) and the melt is drawn to produce a micrometer-scale wire 24 consisting of a metal alloy core encapsulated in glass. The glass is ultimately removed through acid etching or other technique, leaving a pure alloy wire having a diameter between 1 μm and 100 μm. This process is sensitive to several variables, including the nature of the alloy of interest, furnace temperature and heating rate, cooling rate, and draw rate. The Taylor-wire process has been used in the past for dozens of different metals and alloys, ranging from simple copper to complex alloys like iron-cobalt-chromium-nickel-copper and others.

In some embodiments, SMA structures other than wires and microwires may be used to form active homogeneous textile materials. For example, in some embodiments, SMA coils may be used to form active textile materials. SMA coils may be used, for example, to form a knit fabric or knit panels as described above. Other textile patterns may alternatively be used. In some implementations, a combination of SMA coils and SMA wires or microwires may be used to form an active textile material or compression garment.

In some embodiments, braid structures formed from SMA materials are used within compression garments. As is well known, a braid is a textile superstructure composed of individual fibers, yarns, or fabric elements that are “mutually intertwined in tubular form” (see, e.g., Demboski, G. et al., “Textile Structures for Technical Textiles Part II Types and Features of Textile Assemblies,” Bulletin of the chemists and Technologists of Macedonia, 24, 77-86 (2004)). Several different braiding arrangements (e.g., diamond, regular, Hercules), axial configurations (biaxial, triaxial), fiber diameters and porosities, and intertwining angles (from 10-80 degrees) are possible. Braids are commonly used in a variety of different applications ranging from children's toys (e.g., the Chinese finger trap) to advanced carbon fiber materials. Because of their unique architecture, braided structures have the ability to change both length and diameter, as the fiber elements are free to rotate angularly with respect to one another. For this reason, braided. tubes have been utilized in many actuation and morphing engineering structures, including pneumatic artificial muscles, expandable tubing sheaths, and in-vitro stents (see, e.g., Klute, G., et al., “Fatigue Characteristics of McKibben Artificial Muscle Actuators,” Proceedings of the 1998 IEEE/RSJ International Conference on Intelligent Robots and Systems, Victoria, B. C., Canada (1998); Ding, N., “Balloon Expandable Braided Stent with Restraint,” United States (1999); TECHFLEX.COM (2011); Schreiber, F. et al, “Improving the Mechanical Properties of Braided Shape Memory Polymer Stents by Heat Setting,” AUTEX Research Journal, 10 (2010); and Wang, B. et al., “Modeling of Pneumatic Muscle with Shape Memory Alloy and Braided Sleeve,” International journal of Automation and Computing, 7 (2010)).

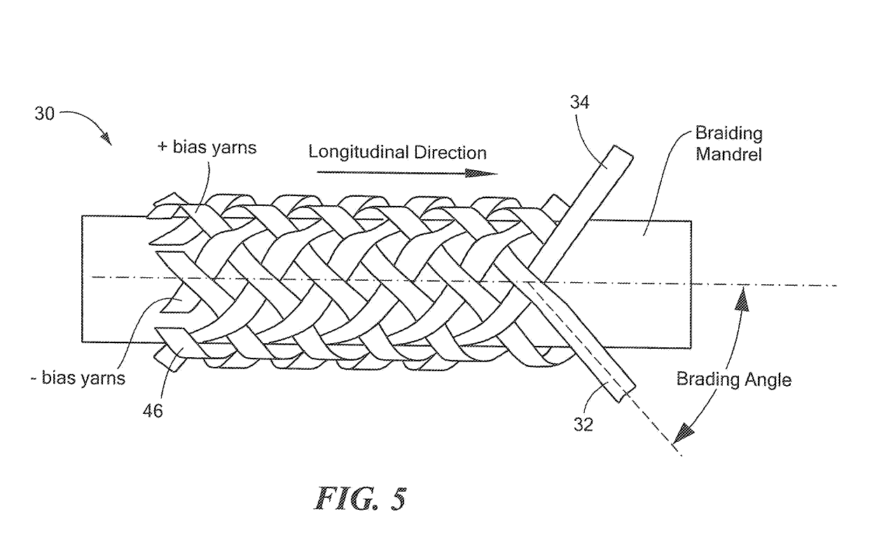

FIG. 5 is a diagram illustrating an exemplary biaxial braid structure 30 that may be formed almost entirely of SMA wire material in accordance with an embodiment. As shown, the bi-axial braid structure 30 includes positive and negative bias yams 32, 34 that are intertwined at angles to one another relative to a longitudinal dimension of the braid 30. Techniques for forming such braids using threads or yams are well known in the art. When formed with SMA materials, braid structures can be used as controllable compression garments. The braid elements may be trained to remember either the fully shortened (i.e., largest diameter) state or the fully extended (i.e., smallest diameter) state. If trained for the fully shortened state (or a state near the fully shortened state), a stimulus will have to be applied to the braid to open it up to allow it to be placed over a body part of interest (i.e., active doffing). Once on, the stimulus may be removed and the braid will passively compress the body part in a desired manner (as the braid cylinder will be designed with a passive diameter smaller than that of the limb of the wearer). If trained for the fully extended state (or a state near the fully extended state), the braid will he loose when no stimulus is being applied and can therefore be easily placed over the body part of interest (as the braid cylinder will be designed with a passive diameter larger than that of the limb of the wearer). When the stimulus is then applied, the braid will compress the body part in the desired manner (i.e., active compression). The stimulus must then remain on the garment as long as compression is to be maintained. Since the braid structure will be comprised of 100% SMA wire (or SMA wire with a small percentage of non-SMA materials with similarly high. melting points), it will be possible to train the braid as a complete textile, enabling the garment to remember complex shapes that would be difficult (if not impossible) to achieve if the SMA. elements were limited to their pre-braid shape training state (as would be the case in a non-homogenous textile). This capability will enable the garment to be trained in specific ways to exploit the natural length-radius relationship of a biaxial braid structure.

Although not shown in the embodiments described above, it should be appreciated that structures may be provided with a compression garment to allow control signals to be applied thereto as a stimulus. In most cases, the control signals will be electrical signals and the structures that are provided to apply the signals may include, for example, at least one energy source, at least one switch, and conductors for coupling the control signals to the SMA material. For example, a battery may be provided for use as an energy source, When a stimulus is to be applied, the switch may be closed to couple the battery to the appropriate SMA structures in the compression garment. The resulting currents will heat up the SMA structures and cause them to revert to a trained shape. To remove the stimulus, the switch may then be opened. The energy source (or a receptacle for same) and the switch may, in some embodiments, be incorporated into the garment itself In some embodiments, compression garments will not include structures for applying a stimulus to the SMA structures of the garment. For example, in some embodiments, externally applied stimuli may be used to control the compression of the garment (e.g., heat, magnetic field, etc.).

For compression garments that use homogeneous SMA textiles, the active textiles must be arranged in a manner that allow applied stimulus signals to reach all operative portions of the garment. In sonic embodiments, it may be desirable to have a single electrical port or contact to feed a control signal. to all active parts of the garment. Thus, an electrical pathway must exist within the garment to allow the control signal to reach all desired portions. By definition, each knit panel or braid is comprised of conductive elements (SMAs are by definition conductive) which enables the transmission of electrical currents throughout the structure through parallel, series, or combination parallel/series circuit configurations (with proper shielding). As panels are assembled, electrical continuity can be maintained by using conductive elements in the binding architecture (e.g., by stitching or lacing the panels or braids together using conductive fibers or stainless steel microwire). An additional embodiment forgoes the use of a powered control system, and relies on heating of the SMA elements through interaction with human skin. Such an architecture is possible (and preferred) if using shape changing elements with activation temperatures below body temperature.

In various embodiments described above, compressive garments were described that performed compression when a stimulus was applied, and that were opened or could be physically opened through deformation of the actuators, when the stimulus was removed. In some embodiments, however, the compressive state may occur when the stimulus is not applied. The stimulus may then be used to remove the compression and open the garment. This may be desired, for example, in an application where the compression state is a fail-safe state. For example, in a space application, a space suit will typically have to maintain a pressurized condition while an astronaut is outside a space vehicle. If a power source fails in such a scenario, the space suit has to remain pressurized. Thus, the suit may be configured to provide compression when no signal is applied (i.e., passive compression) and to release compression when a signal is subsequently applied (i.e., active doffing). In such a compression space suit application, the compression garments described in these embodiments would serve as an inner suit layer to compress the astronaut, and would be one part of a multi-layer suit that also protects against thermal stresses, micrometeoroids, and radiation.

It has been proposed by previous research that in order to create a full-body, highly mobile pressure suit, it may be necessary to map the restraint patterns of the garment to align with the natural lines of non-extension (LoNE) of the wearer's body (see, e.g., Bethke, K., “The Second Skin Approach: Skin Strain Field Analysis and Mechanical. Counter Pressure Prototyping for Advanced Space Suit Design,” Aeronautics and Astronautics, Cambridge, Mass., Massachusetts Institute of Technology (2005); and Iberall, A., “The Experimental Design of a Mobile Pressure Suit,” Journal of Basic Engineering, 251-264 (1970)). These lines, which map contours of minimum stretch/contraction of the human skin as the body moves through its range of motion, signify potential patterns for any semi-rigid structural elements of the garment. By integrating such elements along the LoNE, the elements are less likely to be exposed to significant in-line stresses during movement. Such a technique may be utilized to guide the implementation of active materials designed to augment total body compression capabilities.

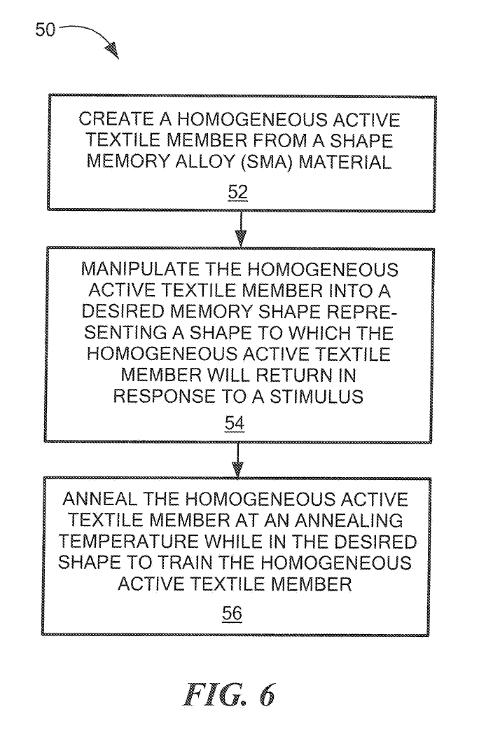

FIG. 6 is a flowchart illustrating a method 50 for use in fabricating a compression garment, First, a homogeneous textile member is formed from a shape memory alloy (SMA) material (block 52), Any SMA material may be used (e.g., NiTi, etc.). In at least one embodiment, a wire or microwire form of the SMA material is used to form the textile. The textile may be fully formed of SMA material or a combination of SMA material and a non-SMA material having a high melting point (i.e., higher than the annealing temperature of the SMA material) may be used. Any of a number of different textile patterns may be used. In one approach, a textile pattern that has a natural expandability or flexibility along a particular axis may be used (e.g., a knit, a braid, etc.).

After the homogeneous textile member has been created, it may be manipulated into a desired memory shape (block 54). This memory shape represents the shape that the textile member will return to in response to a stimulus. In a compression garment, the garment may he designed for active compression or passive compression. If active compression is desired, the memory shape will be one that results in compression to the body part of interest. If passive compression is desired, the memory shape will be one that allows easy donning and doffing of the garment. Because the homogeneous textile member of made fully of SMA material (or a combination of SMA material and a non-SMA material having a high melting point), the member can be annealed as a full unit, thus allowing relatively complex shapes to be achieved.

While in the desired memory shape, the homogeneous textile member may next be annealed at an annealing temperature (block 56). This annealing operation trains the homogeneous textile member to remember the desired memory shape. After being trained, further steps may be taken to complete the compression garment. For example, in some embodiments, a liner or outer covering may be applied to the member to prevent contact of the SMA material with the wearer and/or others. Also, in some implementations, a battery and control device may be added to the garment to provide a mechanism for applying a stimulus signal to the homogeneous textile member. Other actions may also be taken.

Although described above as applying compression to body parts of wearers, it should be appreciated that many of the structures and techniques described herein may also be used to provide compression to structures other than body parts. For example, the ability for a system to remotely constrict around an inanimate object has potential application in flow control (e.g., pumping systems), gasket/mechanical joining elements, cable sheathing that can recover/induce desired shapes or untangle jumbled wires, or as morphing surface coverings for robotic, aerospace, or architectural systems. Many other applications also exist.

Although many structures discussed herein are described as applying compression to a single body part, or only a portion of a body part, it should be appreciated that the disclosed structures may be replicated to generate full garments for users (e.g., a compressive shirt, compressive pants, a full body suit, etc.). Also, a single compressive garment may be manufactured using multiple of the above-described active compressive structures in some embodiments.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims, All publications and references cited herein are expressly incorporated herein by reference in their entirety.

What is claimed is:

1. A compression garment comprising:
a homogeneous active textile member formed from a shape memory alloy (SMA) material to at least partially surround a body part of interest of a wearer for use in providing controllable compression to the body part of interest, the active textile member having a textile pattern with a natural expansion ability along an axis of expansion thereof, wherein the active textile member is trained to return to a predetermined expansion state along the axis of expansion when an external stimulus is applied.

2. The compression garment of claim 1, wherein:
the active textile member is fully formed from SMA material and a non-SMA material that has a melting temperature that is higher than an annealing temperature required to train the SMA material.

3. The compression garment of claim 1, wherein:
the active textile member is fully formed from SMA material.

4. The compression garment of claim 1, wherein:
the active textile member includes a flat knit structure.

5. The compression garment of claim 1, wherein:
the active textile member includes a braid structure.

6. The compression garment of claim 1, wherein:
the active textile member includes a biaxial braid structure.

7. The compression garment of claim 1, wherein:
the active textile member includes an SMA knit panel.

8. The compression garment of claim 1, wherein:
the active textile member comprises a plurality of SMA knit panels that are coupled together, wherein each panel in the plurality of SMA knit panels is trained to return to a predetermined expansion state along a corresponding axis of expansion, and the panels are coupled together with their axes of expansion in substantial alignment.

9. The compression garment of claim 1, further comprising:
at least one terminal for use in applying an electrical stimulus signal to the active textile member, wherein the active textile member is trained to provide compression to the body part of interest in response to application of the electrical stimulus signal to the at least one terminal.

10. The compression garment of claim 1, further comprising:
at least one terminal for use in applying an electrical. stimulus signal to the active textile member, wherein the active textile member is trained to release compression of the body part of interest in response to application of the electrical stimulus signal to the at least one terminal.

11. The compression garment of claim 1, further comprising:
a holder to hold an energy source; and
a switch to controllably couple the energy source to the active textile member as a stimulus signal.

12. The compression garment of claim 1, wherein:
the active textile member is configured to fully surround the body part of interest.

13. The compression garment of claim 1, wherein:
the homogeneous active textile member is formed from an SMA microwire material.

14. A compression garment comprising:
a homogeneous active textile member formed from a Shape memory alloy (SMA) material, wherein the homogeneous active textile member is trained. as an assembled unit to return to a desired shape upon application of a stimulus.

15. The compression garment of claim 14, wherein:
the homogeneous active textile member includes a fiat knit structure.

16. The compression garment of claim 14, wherein:
the homogeneous active textile member includes a braid structure.

17. A compression garment comprising:
a homogeneous active textile member formed from a shape memory alloy (SMA) material, the homogeneous active textile member including a plurality of SMA flat knit panels that are coupled together to form an active textile member adapted to provide controllable compression to a body part of a wearer, wherein each of the SMA flat knit panels in the plurality of SMA flat knit panels is separately trained to return to a desired memory shape in response to a stimulus.

18. The compression garment of claim 17, wherein:
each of the SMA flat knit panels in the plurality of SMA flat knit panels is naturally expandable along an axis thereof and each of the SMA flat knit panels in the plurality of SMA flat knit panels has been trained to return to a similar memory shape, wherein the plurality of SMA flat knit panels are coupled together so that the axes of the panels are substantially aligned.

19. The compression garment of claim 18, wherein:
the homogeneous active textile member is formed as a cuff.

20. A compression garment comprising:
a homogeneous active textile member formed from a shape memory alloy (SMA) material to provide controllable compression to a body part of interest, the homogeneous active textile member including an SMA. braid structure having a fully compressed state and a fully expanded state along an axis of expansion of the braid, wherein the homogeneous active textile member is trained to return to either a compressed state at or near the fully compressed state or an expanded state at or near the fully expanded state in response to a stimulus.

21. The compression garment of claim 20, wherein:
the homogeneous active textile member is trained to return to the compressed state in response to the stimulus and is designed with a passive diameter that is smaller than a diameter of the body part of interest.

22. The compression garment of claim 20, wherein:
the homogeneous active textile member is trained to return to the expanded state in response to the stimulus and is designed with a passive diameter that is larger than a diameter of the body part of interest.

23. A method for use in fabricating a compression garment, comprising:
creating a homogeneous active textile member from a shape memory alloy (SMA) material;
manipulating the homogeneous active textile member into a desired memory shape representing a shape to which the homogeneous active textile member will return in response to a stimulus; and
annealing the homogeneous active textile member at an annealing temperature while in the desired shape to train the homogeneous active textile member.

24. The method of claim 23, wherein:
creating a homogeneous active textile member includes creating an SMA knit textile using SMA wire.

25. The method of dim 23, wherein:
creating a homogeneous active textile number includes creating an SMA braid using SMA wire.
